(19) United States
(12) Patent Application Publication
(10) Pub. No.: US 2026/0227041 A1
(43) Pub. Date: Aug. 6, 2026

(54) BATTERY-POWERED STRING LIGHTS

(71) Applicant: EDDIE B. FOSTER, JR., WESTFRANKFORT, IL (US)

(72) Inventor: EDDIE B. FOSTER, JR., WESTFRANKFORT, IL (US)

(21) Appl. No.: 19/533,027

(22) Filed: Feb. 6, 2026

Related U.S. Application Data
(60) Provisional application No. 63/754,787, filed on Feb. 6, 2025.

(51) Int. Cl. F21S 9/02; F21S 4/10

(52) U.S. Cl. CPC F21S 9/02; F21S 4/10

(57) ABSTRACT

A battery-powered lighting system includes a housing defining an internal cavity configured to removably receive a rechargeable power tool battery. An electrical connector within the housing couples the battery to an electrical circuit that powers one or more lighting outputs through a switch. At least one strand of lights extends externally from the housing. In certain embodiments, the housing is configured as a decorative fixture. In other embodiments, the housing supports a lamp structure having a central light and additional light strands. The system operates without connection to an external electrical outlet, improving portability and safety.

### TECHNICAL FIELD

The present invention relates generally to lighting systems, and more particularly to portable, battery-powered lighting systems utilizing removable rechargeable power tool batteries to power one or more strands of lights and decorative lamp structures for indoor and outdoor use.

### BACKGROUND

Conventional string lights and decorative lighting systems are typically powered by connection to an external electrical outlet. Such systems often require the use of extension cords or proximity to a fixed power source, which limits placement flexibility and can be inconvenient for users. Additionally, plug-in lighting systems may present safety concerns, including an increased risk of fire due to faulty wiring, moisture exposure in outdoor environments, and tripping hazards caused by trailing cords.

Battery-powered lighting options, such as flashlights, rely on proprietary or low-capacity batteries that require frequent replacement or recharging, provide limited runtime, or are not well suited for powering longer strands of lights or higher-output lighting elements. These limitations reduce their practicality for extended use, outdoor applications, or decorative installations requiring multiple light strands.

Accordingly, there exists a need in the art for an improved battery-powered lighting system that is portable, safe, and capable of reliably powering one or more strands of lights without reliance on wall outlets or extension cords. There is a further need for such a system to utilize readily available, high-capacity rechargeable batteries, and to be adaptable to a variety of housing configurations and decorative forms, including both compact fixtures and lamp-style embodiments.

### SUMMARY

In accordance with one aspect of the present disclosure, a battery-powered lighting system is provided. The system includes a housing defining an internal cavity, a battery receptacle configured to removably receive a rechargeable power tool battery, and an electrical connector for electrically coupling the rechargeable power tool battery to the lighting system. At least one strand of lights extends externally from the housing and includes a plurality of light elements. A switch is operatively connected to selectively control delivery of electrical power from the rechargeable power tool battery to the at least one strand of lights, enabling operation without connection to an external electrical outlet.

In accordance with another aspect of the present disclosure, a portable lighting apparatus is provided. The apparatus includes a fixture defining a compartment for receiving a removable rechargeable power tool battery, a cover for retaining the rechargeable power tool battery within the fixture, and an electrical circuit electrically coupled to the rechargeable power tool battery. An on/off switch is mounted to the fixture and controls power supplied to at least one strand of lights extending from the fixture. The apparatus is configured to provide portable lighting powered by the rechargeable power tool battery without reliance on wall outlets or extension cords.

In accordance with yet another aspect of the present disclosure, a battery-powered decorative lamp system is provided. The decorative lamp system includes a housing configured in a decorative shape and defining an internal cavity for receiving a rechargeable power tool battery. A light pole extends from the housing and supports a central light at an upper end thereof. One or more strands of lights extend from the lamp structure and are electrically coupled to the rechargeable power tool battery. A switch controls power supplied to the central light and the one or more strands of lights, allowing the decorative lamp system to operate independently of an external electrical power source.

These and other features and advantages of the present disclosure will be apparent from the following detailed description, taken in conjunction with the accompanying drawings.

### BRIEF DESCRIPTION OF THE DRAWINGS

FIG. 1 is a perspective view of a battery-powered lighting system according to one embodiment of the present invention, illustrating a housing, a removable battery, and a strand of lights extending from the housing.

FIG. 2 is a perspective view of the battery-powered lighting system of FIG. 1, showing insertion of a rechargeable power tool battery into the housing.

FIG. 3 is a perspective view of the battery-powered lighting system of FIG. 1, illustrating the housing configured as a fixture having an on/off switch for selectively powering the strand of lights.

FIG. 4 is an additional perspective view of the battery-powered lighting system, further illustrating the housing, battery, and strand of lights.

FIG. 5 is a perspective view of an alternative embodiment of the present invention, illustrating a decorative lamp configuration in which the housing is shaped as a tiki statue, a light pole extends upwardly from the housing and terminates at a central light, and two strands of lights extend from opposite sides of the light pole.

### DETAILED DESCRIPTION

The following detailed description is provided with reference to the accompanying drawings, in which like reference numerals refer to like elements throughout the various views. The detailed description is intended to illustrate representative embodiments of the present invention and to describe the invention with sufficient particularity to enable a person of ordinary skill in the art to make and use the invention. The detailed description is not intended to limit the scope of the invention, as the invention may be embodied in numerous variations and alternative configurations consistent with the principles and concepts disclosed herein. Unless otherwise indicated, directional terms such as “upper,” “lower,” “top,” “bottom,” “front,” “rear,” “left,” “right,” “inward,” “outward,” “vertical,” “horizontal,” “lateral,” and similar terms are used for convenience in describing the embodiments as illustrated in the drawings, and such terms should not be construed as limiting the invention to any particular orientation during manufacture, installation, or use.

In general, the present invention relates to battery-powered lighting systems that use a removable rechargeable battery, and in particular a rechargeable power tool battery, to power one or more strands of lights. The invention provides a portable and safer alternative to conventional plug-in string lights that require proximity to an electrical outlet and often necessitate extension cords. The invention further provides the ability to house the battery and electrical components within a decorative housing that may take many different forms and shapes, including a compact present-like housing in one embodiment and a decorative lamp configuration in another embodiment. Although multiple embodiments are shown, the underlying concepts are shared and include a housing that supports a battery receptacle or battery receiving structure, electrical connections to couple the battery to the lighting output, and user controls such as a switch to selectively energize the lights.

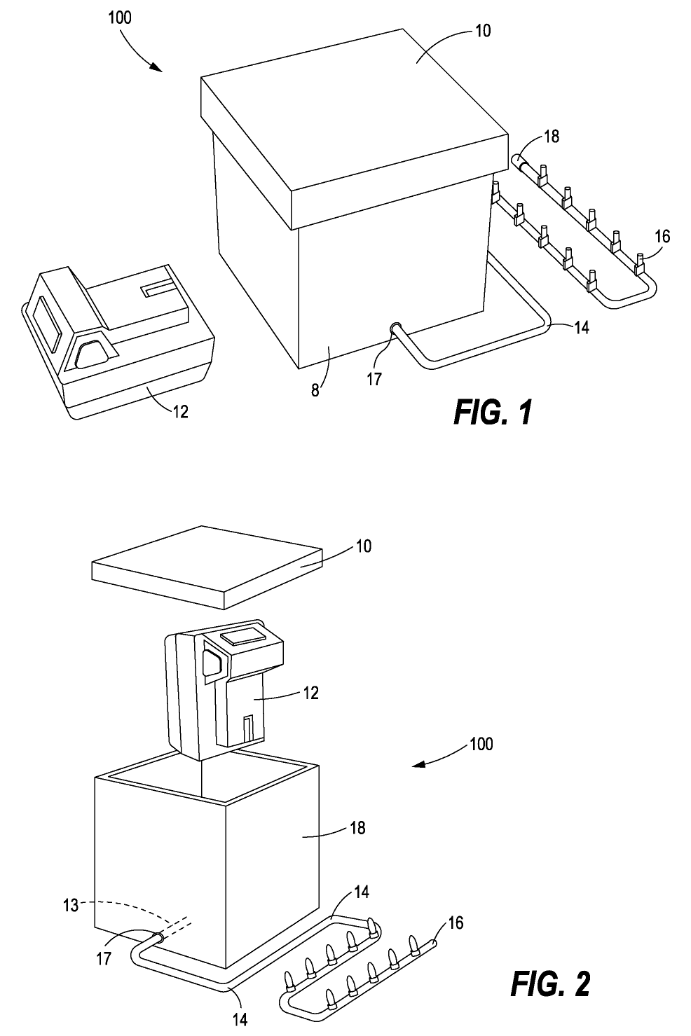

FIG. 1 illustrates a first embodiment of a battery-powered lighting system of the present invention. In FIG. 1, a housing 8 is shown as a generally box-like structure. In the embodiment depicted, the housing 8 is described as a five-sided box, which may be understood as a structure having five primary external faces defining an enclosure. In a representative example, the housing 8 may have a bottom face and four side faces, with an open top that may be covered by a housing cover 10, thereby producing a closed enclosure when assembled. In other representative constructions, the housing 8 may be formed as a substantially closed structure with an access door, hinged lid, removable panel, or other opening feature to provide access to an internal cavity. The housing 8 may be formed from polymeric materials, such as molded plastic, or from metal, composite, wood, or other structural materials, depending on design preference, manufacturing considerations, and intended use environment. In outdoor embodiments, the housing 8 may be formed from materials resistant to ultraviolet exposure, moisture, and temperature cycling, and may be sealed or gasketed to reduce ingress of water or debris.

The housing 8 defines an internal cavity that is sized and shaped to receive at least a portion of a battery 12. In the illustrated embodiment, the battery 12 is a rechargeable power tool battery. The term “power tool battery” as used herein refers to a removable rechargeable battery pack of the type commonly used with handheld power tools, such as drills, drivers, saws, outdoor power equipment, and similar equipment. Such batteries are typically designed as self-contained battery packs that include a set of electrical terminals and a physical interface structure to mechanically couple to a tool or charging cradle. The battery 12 may be selected from a variety of voltages and capacities, and the housing 8 may be dimensioned to accept a particular battery pack format or a range of battery pack formats. In some embodiments, the housing 8 may include an internal fixture or adapter to accept different battery pack brands or battery pack form factors, though the invention is not limited to any particular brand or voltage configuration.

FIG. 1 further illustrates the housing cover 10 and the battery 12 in relation to the housing 8. The housing cover 10 may be a separate component configured to be attached to or removed from the housing 8, allowing a user to access the internal cavity for insertion, removal, replacement, or inspection of the battery 12 and other internal components. In one example implementation, the housing cover 10 may engage with the housing 8 by friction fit, snap features, latches, fasteners, threads, or other coupling mechanisms. Where fasteners are used, they may include screws, bolts, pins, or other mechanical fasteners. Where latches are used, they may include over-center latches, spring clips, or other quick-release mechanisms. In outdoor or moisture-exposed use cases, the housing cover 10 may include a gasket or sealing element to reduce entry of moisture into the internal cavity when the housing cover 10 is installed.

FIG. 1 also depicts an external strand 14 extending outwardly from the housing 8. The external strand 14 may be a flexible electrical cable or cord that supports a plurality of lights 16 disposed along its length. The external strand 14 is shown as extending from the housing 8 and terminating at a terminal end 18. In practice, the external strand 14 may be configured as a string light assembly in which multiple light elements are spaced along the length of a flexible conductor. The external strand 14 may be configured for decorative lighting and may be used in indoor environments, such as on trees, mantels, and room decor, or in outdoor environments, such as around patios, fences, decks, and holiday displays. The lights 16 may be any suitable light type, such as incandescent bulbs or, more preferably, light emitting diodes (LEDs), which may provide improved energy efficiency, reduced heat output, longer life, and enhanced safety.

The lights 16 may be configured as individual light modules. Each light module may include a light source (such as an LED), a lens or diffuser, and an electrical coupling to the conductors of the external strand 14. In some embodiments, the lights 16 may be sealed or potted to enhance moisture resistance. The spacing between adjacent lights 16 may vary based on the intended aesthetic effect and brightness distribution. Additionally, the external strand 14 may be constructed in different lengths depending on the intended application. In certain embodiments, multiple external strands 14 may be provided, or a single external strand 14 may include connectors that allow multiple strand segments to be coupled together in series or in parallel. The present invention contemplates embodiments in which one housing 8 can power one external strand 14 or multiple strands.

In the embodiment illustrated in FIG. 1, the external strand 14 exits the housing 8 through an opening, grommet, or strain relief feature. This feature may be designed to prevent abrasion of the external strand 14 and to reduce stress on internal electrical connections. A strain relief component may be provided at the exit point to prevent pulling forces applied to the external strand 14 from being transmitted to internal connectors or solder joints. In moisture-resistant embodiments, the exit point may be sealed with a grommet, compression fitting, or potting compound to reduce moisture ingress.

The terminal end 18 may be a simple end termination of the external strand 14, such as a sealed end cap or molded termination, or it may include a connector that allows connection to additional strands, accessories, or decorative elements. For example, the terminal end 18 could include a plug and socket arrangement for daisy-chaining multiple strands, provided the electrical design supports safe current levels and power distribution. In other embodiments, the terminal end 18 may include a protective cap, a hanging loop, or a retention feature used to secure the strand in place.

FIG. 2 illustrates the battery 12 being inserted into the housing 8. In this view, the housing 8 is shown in a configuration allowing access to the battery receptacle region, enabling the battery 12 to be slid, seated, or otherwise positioned within the internal cavity of the housing 8. The battery 12 may be inserted along a guide path that ensures alignment of electrical terminals of the battery 12 with corresponding contacts of an electrical connector housed within the housing 8. The housing 8 may include rails, channels, grooves, or other guide features that match the geometry of the battery 12, thereby helping the user insert the battery 12 in the correct orientation. Additionally, the housing 8 may include a stop surface that defines a fully seated position, ensuring that the battery 12 is properly engaged with the electrical connector for reliable power delivery.

In certain power tool battery formats, the battery pack includes mechanical locking features that engage with a tool to prevent accidental disengagement. The present invention may incorporate corresponding lock features within the housing 8, such that the battery 12 may “click” or lock into place when fully inserted. Alternatively, the housing 8 may retain the battery 12 by friction, by the housing cover 10, or by an internal clamp or latch. In embodiments using the housing cover 10 as part of the retention mechanism, the user may insert the battery 12 into the housing 8 and then install the housing cover 10 to secure the battery 12 within the internal cavity.

FIG. 2 is also representative of the concept that the battery 12 may be easily removable and replaceable. This enables a user to swap a depleted battery 12 for a charged battery 12, extending operating time without requiring the system to be tethered to a wall outlet. This further facilitates use in environments where outlets are unavailable, such as outdoor areas, temporary installations, camping, and holiday displays away from structures. The removable nature of the battery 12 also supports improved safety by eliminating reliance on long extension cords and by reducing hazards associated with damaged or overloaded cords.

Although the figures referenced in the user’s description indicate that certain elements may have been misnumbered in some views, the detailed description herein maintains consistent reference numerals for clarity and continuity. Accordingly, the battery 12 is described as being inserted into the housing 8 in FIG. 2, consistent with the other figures and the overall invention description.

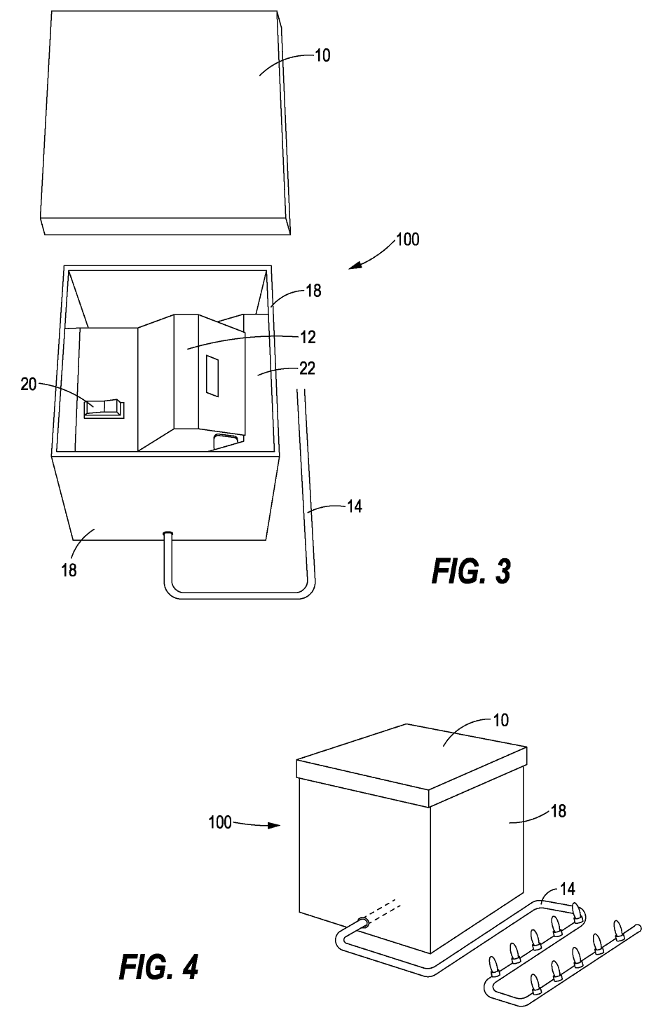

FIG. 3 illustrates the housing 8 as a fixture configured to receive the battery 12 and provide electrical power to the external strand 14 and the lights 16. In this view, an on/off switch 20 is shown on the housing 8. The on/off switch 20 may be mounted on an exterior surface of the housing 8, allowing a user to selectively energize or de-energize the lights 16 without removing the housing cover 10 or accessing the internal cavity. The on/off switch 20 may be a toggle switch, rocker switch, push-button switch, slide switch, rotary switch, or other suitable switching mechanism. In some embodiments, the on/off switch 20 may include multiple modes, such as steady on, flashing, dimming, or timed operation. In other embodiments, the on/off switch 20 may be a simple two-state switch controlling electrical continuity between the battery 12 and the external strand 14.

Internally, the housing 8 may include an electrical circuit that couples the battery 12 to the external strand 14. This electrical circuit may include an electrical connector configured to engage with the battery terminals of the battery 12. The electrical connector may be formed from conductive contacts, such as spring contacts, blade contacts, pin contacts, or other electrical contact structures suited to the battery format. The electrical circuit may also include wiring, conductors, and protective components. For example, the housing 8 may include internal wiring that connects the electrical connector to the on/off switch 20 and then to the conductors of the external strand 14. The internal wiring may be insulated and routed to minimize interference with battery insertion. The system may also include a fuse, resettable fuse, thermal protection, current limiting device, or other safety component to reduce the risk of short-circuits or overheating. Because power tool batteries may be capable of delivering substantial current, protective elements may be advantageous to ensure safe operation of the lighting load.

In addition, the housing 8 may include a voltage conversion component depending on the battery 12 voltage and the required voltage for the lights 16. For example, if the lights 16 are designed to operate at a lower voltage than the battery 12, a voltage regulator, buck converter, or other DC-DC conversion circuit may be included within the housing 8. In some embodiments, the lights 16 may be configured to operate directly from the battery voltage, particularly where the lights 16 are arranged in series/parallel configurations compatible with the battery 12 voltage. In other embodiments, the housing 8 may incorporate driver circuitry for LEDs, such as constant current drivers, to maintain consistent brightness and efficiency across the battery discharge curve.

The housing 8 may serve multiple functions beyond merely holding the battery 12. As shown in FIG. 1 and FIG. 3, the housing 8 may be aesthetically designed to resemble a decorative object. One described decorative configuration is a Christmas present-like appearance. In such an embodiment, the housing 8 may be shaped and ornamented to look like a gift box, potentially including patterns, textures, ribbons, bows, or other decorative features. This decorative aspect may allow the housing 8 to blend into holiday decor and conceal the presence of the battery 12. In addition, the housing 8 may be configured to hold or conceal excess cable length of the external strand 14, contributing to a neat appearance. For example, the internal cavity may include storage space for coiling excess portions of the external strand 14, or the housing 8 may include external features that allow wrapping the strand.

FIG. 3 further illustrates that the housing 8 is a fixture that receives the battery 12 in a stable manner. The housing 8 may be configured to rest on a surface, be hung, be mounted to a structure, or otherwise supported. In certain embodiments, the housing 8 may include mounting features such as holes, slots, hooks, loops, brackets, adhesive pads, or magnets. These mounting features may allow the housing 8 to be positioned in a convenient location while the external strand 14 is arranged in the desired decorative pattern. The housing 8 may also include feet or stabilizing elements for tabletop placement. In outdoor contexts, the housing 8 may include stakes or tie-down points.

FIG. 4 is described as an additional perspective view of the battery-powered lighting system, further illustrating the housing 8, the battery 12, and the external strand 14 with the plurality of lights 16. FIG. 4 may emphasize the overall arrangement and relationship between components, including the exit of the external strand 14 from the housing 8, the placement of the housing cover 10, and the general aesthetic presentation. Although FIG. 4 is not separately described in the user’s earlier summary beyond being part of the set of FIGS. 1-4, it may be understood to provide supplemental depiction of the same core embodiment, potentially showing different angles or additional details. In patent practice, such a view may help illustrate how the housing 8 encloses the battery 12 while allowing the external strand 14 to extend outwardly for decoration.

In operation of the embodiment shown in FIGS. 1-4, a user may obtain a charged rechargeable power tool battery 12 and insert it into the battery receptacle within the housing 8 as shown in FIG. 2. The battery 12 is guided into the proper position and electrically coupled to the internal electrical connector. The user may then install the housing cover 10 (if not already installed) to secure the battery 12 and to close the housing 8. With the external strand 14 extending outwardly, the user may arrange the external strand 14 and position the lights 16 as desired, such as around a holiday display, along a railing, or in another decorative arrangement. When the user wishes to energize the lights 16, the user actuates the on/off switch 20 to the “on” position, thereby completing the electrical circuit between the battery 12 and the lights 16. The lights 16 illuminate, providing the desired decorative effect. When the user wishes to turn off the lights, the user actuates the on/off switch 20 to the “off” position, thereby interrupting power delivery and extinguishing the lights 16. When the battery 12 becomes depleted, the user may remove the housing cover 10 and remove the battery 12 to recharge it using a conventional power tool battery charger, or may replace it with another charged battery, thereby maintaining continuous operation if desired.

The ability to use a rechargeable power tool battery 12 confers several advantages. Power tool batteries are widely available and are often already owned by users who have power tools. They typically provide relatively high capacity compared to small consumer batteries, enabling longer run times for string lights. They are designed to be rechargeable and to interface with charging systems, reducing waste from disposable batteries. The cordless nature reduces reliance on power outlets and eliminates extension cords, thereby reducing tripping hazards. The elimination of AC mains voltage and extension cords can also reduce certain risks associated with faulty wiring or cord damage in conventional plug-in string lights, particularly in outdoor or damp conditions.

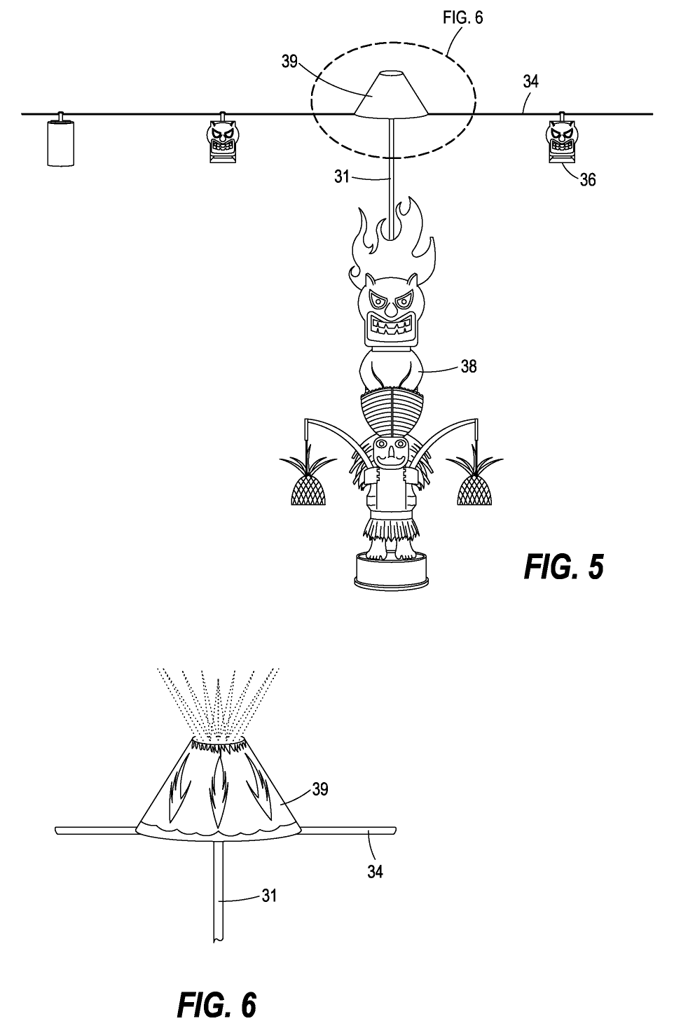

While FIGS. 1-4 describe one representative housing shape, the invention expressly contemplates that the housing 8 may take many other shapes and decorative forms. FIG. 5 illustrates an additional embodiment that emphasizes this flexibility and further demonstrates an embodiment that functions as a lamp-like structure with extending string lights. In FIG. 5, the housing 8 is shaped like a tiki statue. This embodiment shows that the housing 8 does not need to be a box or present-like structure and may instead be formed as a decorative statue, figurine, sculpture, or themed object. The tiki statue configuration is representative of a tropical or novelty decor style, but the same principles apply to other decorative themes.

In the embodiment of FIG. 5, the housing 8 still defines an internal cavity and includes a battery receptacle configured to removably receive a rechargeable power tool battery 12. The battery 12 in this embodiment may be the same type described above, and the internal electrical connector and circuitry may similarly couple the battery 12 to the lighting outputs. The housing 8 may include an access opening, removable panel, or cover portion to permit insertion and removal of the battery 12. In some embodiments, the access opening may be located on the back, bottom, or another less-visible region of the tiki statue to preserve the aesthetic appearance. The housing 8 may include internal retention features to hold the battery 12 securely during use.

Extending upwardly from the housing 8 in FIG. 5 is a light pole 31. The light pole 31 may be a structural member that supports a central/top light 39. The light pole 31 may be formed as a rigid tube, rod, column, or post that is mechanically coupled to the housing 8. The coupling may be integral (molded as one piece with the housing 8) or may be assembled using fasteners, adhesive, threaded engagement, or other mechanical attachment. The light pole 31 may provide a conduit for electrical wiring that supplies power from the battery 12 within the housing 8 to the central/top light 39 and to other lighting components. In some embodiments, the light pole 31 may be hollow to allow routing of wires internally, thereby improving appearance and protecting the wiring from damage. In other embodiments, the light pole 31 may include external channels or coverings for wire routing.

The central/top light 39 is positioned at or near the top end of the light pole 31. The central/top light 39 may be configured similarly to a light on a normal lamp, meaning it may function as a primary illumination source rather than purely decorative point lights. For example, the central/top light 39 may include a lamp-style bulb, an LED lamp module, or another light source capable of providing ambient lighting. The central/top light 39 may be covered by a shade, diffuser, lens, or decorative element depending on the design. The central/top light 39 may be oriented upwardly, outwardly, or downwardly depending on the intended lighting effect. The central/top light 39 may also be configured to provide warm white light, cool white light, colored light, or multi-color light.

In addition to the central/top light 39, FIG. 5 shows two strands of lights 34 extending on both sides of the central/top light 39. These two strands of lights 34 may be structurally and electrically similar to the external strand 14 described in FIGS. 1-4, but in this embodiment they are arranged in a lateral configuration relative to the light pole 31. Each strand of lights 34 includes multiple light elements along its length. The strands of lights 34 may extend outwardly in opposite directions, creating a symmetrical decorative display. These strands of lights 34 may be arranged for accent lighting, decorative flair, or to create a unique lamp-and-string-light combination. The strands of lights 34 may be flexible, allowing them to drape, curve, or be positioned around nearby objects. In some embodiments, the strands of lights 34 may be attached at one end to the light pole 31 and extend outwardly from that attachment point. In other embodiments, the strands of lights 34 may extend from a region near the central/top light 39, or from a junction element that combines power distribution between the lamp-style light and the strands.

The inclusion of a central/top light 39 and side-extending strands of lights 34 demonstrates that the invention can support both a lamp-like lighting function and a string-light decorative function. This configuration may be desirable in settings such as patios, themed rooms, outdoor gatherings, or events where a combination of ambient lighting and decorative string lights is desired. The tiki statue housing 8 provides a decorative base that conceals the battery 12 and electrical circuitry while contributing to a themed aesthetic. In this manner, the embodiment of FIG. 5 not only powers string lights without a wall outlet but also powers a lamp-style light without a wall outlet, further expanding the utility of the battery-powered approach.

The embodiment of FIG. 5 may include a switch (such as switch 20, though the switch in FIG. 5 may be depicted with a different number or in a different location) to allow user control of the central/top light 39 and the strands of lights 34. In one configuration, a single switch may control both the central/top light 39 and the strands of lights 34 together. In another configuration, the system may include multiple switches or a multi-position switch to independently control the central/top light 39 and the strands of lights 34. For example, the user might wish to illuminate only the central/top light 39 for ambient lighting, only the strands of lights 34 for decorative accent, or both together for a combined effect. The switch mechanism may be located on the housing 8, on the light pole 31, or in-line on one of the strands. In still other embodiments, controls may be integrated with a controller that provides modes such as dimming, color changes, flicker effects, or timed operation, though such optional features are not required for the core battery-powered concept.

From an electrical standpoint, the embodiment of FIG. 5 may include internal wiring that distributes power from the battery 12 to multiple outputs. A junction within the housing 8 or within the light pole 31 may provide branching to supply the central/top light 39 and the two strands of lights 34. As noted above, if voltage conversion or current regulation is used, such components may be placed within the housing 8 to protect them and to maintain a consistent appearance. Because the central/top light 39 may require different electrical characteristics than the strands of lights 34, the system may incorporate separate drivers or regulation circuits for each lighting portion. For example, the central/top light 39 may be driven at a different current level or voltage than the strands of lights 34. Alternatively, the system may standardize the lighting components to operate under a common regulated voltage bus, simplifying design.

Mechanically, the light pole 31 must be sufficiently rigid to support the central/top light 39 and to withstand forces applied during handling or use. The light pole 31 may be reinforced with internal ribs, thicker walls, or stronger materials. The connection between the light pole 31 and the housing 8 may be reinforced to prevent wobble. In embodiments intended for outdoor use, the light pole 31 and housing 8 may be designed to withstand wind loads and incidental impacts. The base (housing 8) may be weighted or shaped for stability to prevent tipping, especially if the central/top light 39 is elevated. The battery 12 itself may contribute weight to the base, enhancing stability. Additional weighting may be provided if desired.

The tiki statue shape of the housing 8 in FIG. 5 may incorporate various sculpted features, such as facial details, carvings, texture, and other ornamental design elements. These elements are decorative and may be varied widely without departing from the invention, provided that the housing 8 retains an internal cavity and supports the battery receptacle and electrical components. The housing 8 may be formed by molding, casting, carving, 3D printing, or other manufacturing techniques. For example, the housing 8 could be injection molded plastic with a textured surface, or it could be formed from resin or composite materials. In addition, the housing 8 may be painted or coated to achieve the desired aesthetic.

The embodiment of FIG. 5 demonstrates that the invention is not limited to a “box” configuration and that the battery-powered lighting concept may be integrated into a variety of decorative objects. This allows the battery-powered lighting system to be incorporated into themed decor or seasonal displays in a way that appears intentional and visually appealing. The battery power source is thus not merely a functional component but can be incorporated into a decorative design.

Returning to the broader scope, the invention may encompass multiple variations and additional features consistent with the embodiments shown. For example, the external strand 14 (or the strands of lights 34) may be removable from the housing 8 via a connector, enabling replacement of the strand if damaged or enabling substitution of different strand types. In some embodiments, a connector within the housing 8 may allow the external strand 14 to be unplugged. In other embodiments, the external strand 14 may be permanently connected. The lights 16 may be configured to emit a single color or multiple colors. They may be steady or flickering. They may be configured with decorative covers (such as small bulbs, globes, stars, or other shapes). The external strand 14 may be configured with insulation rated for outdoor use.

The housing 8 may include additional features such as a handle for carrying, hooks for hanging, or clips for attaching to structures. The housing 8 may include a battery level indicator, such as LEDs that indicate remaining battery charge. The housing 8 may include a timer function to automatically shut off the lights after a preset duration. The housing 8 may include a low-voltage cutoff to avoid over-discharging the battery 12. Because some power tool batteries have built-in protective circuitry, the system may rely on the battery’s internal protections; however, additional protections may be included in the housing 8 for redundancy.

In some embodiments, the system may include a retractable cord mechanism to manage the external strand 14. While not required, such a mechanism could allow the external strand 14 to be retracted into the housing 8 for storage. In other embodiments, the housing 8 may include an internal spool around which the external strand 14 can be wound. Alternatively, the housing 8 may include external winding features. These features may be particularly useful when the housing 8 is used as a decorative object and the user desires a neat appearance when the lights are not in use.

In embodiments where multiple strands are supported, the housing 8 may include multiple output ports. Each output port may be connected to the battery 12 through the switch 20 and potentially through a controller. The outputs may be parallel to deliver power to multiple strands simultaneously. In such embodiments, current distribution and protection may be important. The system may incorporate fuses for each output or may include a common fuse sized to protect overall wiring. The system may also incorporate connectors designed to prevent reverse polarity or incorrect insertion.

The external strand 14 (and the strands of lights 34) may include insulation, outer jackets, and conductors sized appropriately for the current. In LED implementations, current may be relatively low, allowing small conductors and improved flexibility. The lights 16 may be integrated into the strand by molding or by sealing around the light modules. In weather-resistant embodiments, each light module may be sealed to prevent water ingress.

In use environments such as holiday decorations, it is common for users to string lights across long distances, sometimes using extension cords. The present invention reduces such reliance by providing a local battery power source. The present invention may be used, for example, to decorate a yard or trees without running cords across walkways, reducing tripping hazards. The present invention may be used on balconies or patios where outlets are limited. It may be used during camping or outdoor events where power is unavailable. The portability of the battery 12 allows the system to be relocated easily.

For the embodiments shown in FIGS. 1-4, the five-sided box housing 8 may be dimensioned to accommodate the battery 12 while still appearing like a small decorative present. For instance, the housing 8 may have proportions similar to common gift boxes used in holiday displays. The housing cover 10 may appear as a lid. The external strand 14 may exit from a side or top region depending on the desired appearance. The switch 20 may be placed on a bottom or rear surface to conceal it, or on a side surface for accessibility. In some decorative implementations, the switch 20 may be concealed behind a ribbon-like element or under a decorative flap.

For the FIG. 5 embodiment, the tiki statue housing 8 may be sized to provide stable support for the light pole 31. The battery 12 may be inserted through a rear access panel. The switch may be integrated as a decorative element (for example, a carved button) or may be discretely located. The central/top light 39 may have a shade styled to match the tiki theme. The strands of lights 34 may be styled with tropical-themed covers (such as small lanterns or colored globes). These variations are illustrative of how the invention can be customized aesthetically while maintaining core functional structure.

In all embodiments, the battery 12 provides a DC power source. Many power tool batteries provide DC voltages such as 12V, 18V, 20V nominal, 24V, 36V, or other values. The system may be designed to work with one selected voltage class. For example, a system may be designed specifically for an 18V-class battery, with internal regulation converting that to a lower voltage suitable for a string of LEDs. Alternatively, the system may accept multiple voltage ranges by incorporating a wide-input regulator. The selection of the electrical design may depend on desired brightness, number of lights, and desired runtime.

In addition, because power tool batteries often incorporate battery management systems, they may include features such as overcurrent protection, overtemperature protection, and undervoltage protection. The system may be designed to cooperate with such features. For example, the system’s current draw may be limited to avoid triggering battery protection. The system may be designed to present a stable load to the battery. The switch 20 may be selected to handle the battery voltage and current safely.

In terms of assembly, the housing 8 may be manufactured in two or more parts. The housing cover 10 may be manufactured separately. Internal components such as the electrical connector, wiring, circuit board, switch 20, and strain relief features may be installed within the housing 8 during assembly. The external strand 14 may be fed through the strain relief opening and connected to the internal wiring. The housing cover 10 may then be attached. In the FIG. 5 embodiment, the light pole 31 may be installed and wiring routed through it to the central/top light 39 and the strands of lights 34.

It will be understood that while specific reference numerals and component arrangements are described, the invention is not limited to the exact arrangement shown. For instance, the battery receptacle may be oriented differently. The battery 12 may be inserted from the side, bottom, or top. The external strand 14 may exit from different locations. The switch 20 may be located in various positions. The housing cover 10 may be hinged or fully removable. The central/top light 39 may be directly mounted to the housing 8 without a light pole 31 in some lamp-like embodiments. The strands of lights 34 may be attached to the housing 8 instead of the light pole 31. These variations remain within the spirit of the invention, provided that the system uses a removable rechargeable power tool battery to power decorative lights without requiring connection to a wall outlet.

The drawings thus illustrate representative embodiments in which a decorative housing 8 is used as a battery fixture to power lighting. FIGS. 1-4 illustrate a compact housing configuration where an external strand 14 with multiple lights 16 extends outwardly from the housing 8 and is controlled by a switch 20, with the battery 12 retained within the housing 8 by a housing cover 10. FIG. 5 illustrates an alternative decorative housing configuration (a tiki statue) in which a lamp-like arrangement is formed by a light pole 31 supporting a central/top light 39, and two strands of lights 34 extend laterally from the vicinity of the central/top light 39, thereby demonstrating that the housing 8 may take many decorative forms and that the battery-powered concept may be integrated into lamp-style embodiments in addition to string-light embodiments.

Although the foregoing description provides detailed examples and elaboration regarding structure and function, it should be appreciated that numerous substitutions, modifications, and variations may be made without departing from the scope of the invention as claimed. The described embodiments are illustrative rather than limiting, and the invention encompasses all equivalents and variations consistent with the concepts disclosed herein.

What is claimed is:

1. A battery-powered lighting system, comprising:
a housing defining an internal cavity;
a battery receptacle formed in the housing and configured to removably receive a rechargeable power tool battery;
an electrical connector within the housing adapted to electrically couple with the rechargeable power tool battery when the rechargeable power tool battery is received in the battery receptacle;
at least one strand of lights extending externally from the housing, the at least one strand of lights including a plurality of light elements electrically coupled to the electrical connector; and
a switch operatively connected between the rechargeable power tool battery and the at least one strand of lights, the switch selectively controlling electrical power supplied to the at least one strand of lights,
wherein the housing supports operation of the at least one strand of lights without connection to an external electrical outlet.

2. The battery-powered lighting system of claim 1, wherein the housing is a five-sided box.

3. The battery-powered lighting system of claim 1, wherein the housing includes a removable housing cover providing access to the internal cavity.

4. The battery-powered lighting system of claim 1, wherein the rechargeable power tool battery is selected from a group of batteries used with handheld power tools.

5. The battery-powered lighting system of claim 1, wherein the at least one strand of lights includes a terminal end opposite the housing.

6. The battery-powered lighting system of claim 1, wherein the plurality of light elements are light emitting diodes.

7. The battery-powered lighting system of claim 1, wherein the housing is configured to power a plurality of strands of lights extending from the housing.

8. The battery-powered lighting system of claim 7, wherein the plurality of strands of lights are connectable in series.

9. The battery-powered lighting system of claim 1, wherein the switch is mounted on an exterior surface of the housing.

10. The battery-powered lighting system of claim 1, wherein the housing is configured to resemble a decorative object.

11. A portable lighting apparatus, comprising:
a fixture defining a compartment sized and shaped to receive a removable rechargeable power tool battery;
a cover removably coupled to the fixture to retain the rechargeable power tool battery within the compartment;
an electrical circuit disposed within the fixture and electrically coupled to the rechargeable power tool battery;
an on/off switch mounted to the fixture and electrically coupled to the electrical circuit; and
at least one strand of lights extending from the fixture, the at least one strand of lights including a plurality of light elements powered by the rechargeable power tool battery through the electrical circuit.

12. The portable lighting apparatus of claim 11, wherein the fixture is a five-sided box.

13. The portable lighting apparatus of claim 11, wherein the fixture is configured to eliminate a need for an extension cord.

14. The portable lighting apparatus of claim 11, wherein the fixture is configured for outdoor use.

15. The portable lighting apparatus of claim 11, wherein the fixture reduces fire hazards associated with plug-in lighting systems.

16. The portable lighting apparatus of claim 11, wherein the fixture secures the rechargeable power tool battery during operation.

17. A battery-powered decorative lamp system, comprising:
a housing defining an internal cavity and configured in a decorative shape;
a battery receptacle formed in the housing and configured to removably receive a rechargeable power tool battery;
an electrical connector within the housing adapted to electrically couple with the rechargeable power tool battery;
a light pole extending upwardly from the housing;
a central light mounted at a top end of the light pole and electrically coupled to the rechargeable power tool battery;
two strands of lights extending laterally from the light pole, each strand of lights including a plurality of light elements electrically coupled to the rechargeable power tool battery; and
a switch operatively connected to control electrical power supplied to the central light and the two strands of lights.

18. The battery-powered decorative lamp system of claim 17, wherein the housing is shaped as a tiki statue.

19. The battery-powered decorative lamp system of claim 17, wherein the central light is configured as a lamp-style light.

20. The battery-powered decorative lamp system of claim 17, wherein the two strands of lights extend from opposite sides of the light pole.
